(19) United States
(12) Patent Application Publication
(10) Pub. No.: US 2026/0160780 A1
(43) Pub. Date: Jun. 11, 2026

(54) SYSTEMS AND METHODS FOR COLLECTING DATA USING WEARABLE SENSOR DATA

(71) Applicant: Quanata, LLC, San Francisco, CA (US)

(72) Inventor: Charles Bennett Smith, Livermore, CA (US)

(21) Appl. No.: 18/970,476

(22) Filed: Dec. 5, 2024

(51) Int. Cl. G01P 13/00

(52) U.S. Cl. CPC G01P 13/00

(57) ABSTRACT

A method can include determining whether a user is wearing one or more wearable electronic devices. When the user is determined to be wearing the one or more wearable electronic devices, the user can be wearing the one or more wearable electronic devices on, over, or in a body part of the user. After the user is determined to be wearing the one or more wearable electronic devices, the method can include conducting an analysis of sensor data detected by one or more sensors of the one or more wearable electronic devices, and determining whether the user is a current operator of a vehicle based on the analysis of the sensor data. Other embodiments are disclosed.

### FIELD OF THE DISCLOSURE

The present disclosure generally relates to collecting data for use in telematics systems.

### BACKGROUND

Telematics systems often use a global positioning system (GPS) on a person's smartphone to collect GPS data, accelerometer data, gyroscope data, and magnetometer data. These telematics systems often attempt to use this GPS data to determine whether the person is performing a particular action. However, the GPS data collected by smartphones often needs to be validated to confirm whether the person is actually performing the particular action. Therefore, systems and methods are desired to validate or verify GPS data used in telematics systems.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of different components of a computer system that are suitable for implementing an exemplary embodiment of the systems disclosed in FIGS. 3 and 4;

FIG. 2 illustrates a representative block diagram of an example of the elements included in the circuit boards inside a chassis of the computer system of FIG. 1;

FIG. 3 illustrates a system for collecting data, according to one exemplary embodiment;

FIG. 4 illustrates another system for collecting data, according to one exemplary embodiment; and

FIGS. 5, 6, and 7 illustrate a flow chart for a method for collecting data, according to one exemplary embodiment.

The figures depict embodiments for purposes of illustration only. One skilled in the art will readily recognize from the following discussion that other embodiments of the systems and methods illustrated herein can be employed without departing from the principles of the technology described herein.

### DETAILED DESCRIPTION OF THE DRAWINGS

The present embodiments can generally relate to collecting data, which can include, inter alia, improving telematics systems, validating data that is collected, verifying the integrity of such data, determining whether a person in a moving vehicle is the driver or other operator of the vehicle or merely a passenger, determining that telematics data for a moving vehicle is associated with a particular driver or other operator, using additional information collected from a wearable device to improve activity classification, and/or using telematics data collected by one electronic device to validate or verify telematics data collected by another electronic device. Current telematics technology can track the movement of vehicles, but such telematics technology is limited and does not, among other things, determine with accuracy whether a person inside of the moving vehicle is the driver or other operator or whether a smartphone collecting GPS data of a moving vehicle is the smartphone of the driver or other operator of the moving vehicle or a passenger within the moving vehicle.

More specifically, various embodiments can include a method being implemented via execution of computing instructions configured to run on one or more processors and stored on one or more non-transitory computer-readable media. The method can include determining whether a user is wearing one or more wearable electronic devices. When the user is determined to be wearing the one or more wearable electronic devices, the user can be wearing the one or more wearable electronic devices on, over, or in a body part of the user. After the user is determined to be wearing the one or more wearable electronic devices, the method can further include conducting an analysis of sensor data detected by one or more sensors of the one or more wearable electronic devices, and determining whether the user is a current operator of a vehicle based on the analysis of the sensor data.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations.

The operations can include determining whether a user is wearing one or more wearable electronic devices. When the user is determined to be wearing the one or more wearable electronic devices, the user can be wearing the one or more wearable electronic devices on, over, or in a body part of the user. After the user is determined to be wearing the one or more wearable electronic devices, the operations can further include conducting an analysis of sensor data detected by one or more sensors of the one or more wearable electronic devices, and determining whether the user is a current operator of a vehicle based on the analysis of the sensor data.

In further embodiments, a non-transitory computer readable storage medium storing computing instructions can be provided. The computing instructions, when run on one or more processors, can cause the one or more processors to perform operations including determining whether a user is wearing one or more wearable electronic devices. When the user is determined to be wearing the one or more wearable electronic devices, the user can be wearing the one or more wearable electronic devices on, over, or in a body part of the user. After the user is determined to be wearing the one or more wearable electronic devices, the operations can further include conducting an analysis of sensor data detected by one or more sensors of the one or more wearable electronic devices, and determining whether the user is a current operator of a vehicle based on the analysis of the sensor data.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to determine a discount for an insurance premium of an automobile or health insurance policy. In other embodiments, the methods, systems, and non-transitory computer readable storage media can be used to make an employment decision about hiring or retaining employees or contractors to drive vehicles. In further embodiments, the methods, systems, and non-transitory computer readable storage media can be used to evaluate a person's fitness to drive when renewing the person's driver's license. In additional embodiments, the methods, systems, and non-transitory computer readable storage media can be used to validate telematics data detected by a person's mobile electronic device, verify the integrity of such telematics data, etc.

In many embodiments, the techniques described herein can provide one or more practical applications and technological improvements. The techniques described herein can provide a technical improvement to telematics data. As a first example, the techniques described herein can be used to implicitly validate telematics data and/or verify the integrity of such data. The techniques described herein can provide improvement over conventional approaches that merely use the telematics data without validating the data and/or verifying the integrity of such data. Accordingly, the techniques described herein can be used to combat fraud and other problems when the telematics data is used to determine discounts in insurance premiums, to make employee or contractor hiring or retaining decisions, to renew a driver's license, etc. In many embodiments, the techniques described herein do not require or otherwise rely upon user input to indicate whether the user was the operator of a vehicle for a vehicle trip, although the techniques can use such input to confirm a determination that the user was the operator. The techniques described herein also can directly and automatically determine operator status, and do not need to infer operator status based on a position of a mobile device within a moving vehicle. Additionally, the techniques described herein are less likely to be confused or determine erroneous conclusions when multiple mobile devices are located in a moving vehicle and collecting telematics data about the same vehicle trip. As such, these techniques can increase the confidence of users in an insurance program's decision-making ability and can increase satisfaction with the insurance program when the insurance program uses such determinations to calculate discounts on insurance premiums.

As an additional example, the systems and methods described herein can use sensor data collected by one electronic device to validate sensor data collected by another electronic device and/or verify the integrity of such data. As another example, the techniques described herein can be used to conserve battery power for a mobile electronic device of an operator of a vehicle because one or more sensors of the mobile electronic device can be turned on and off. The techniques described herein can provide improvement over conventional approaches that do not perform one or more of such functions.

### Exemplary Computer Systems

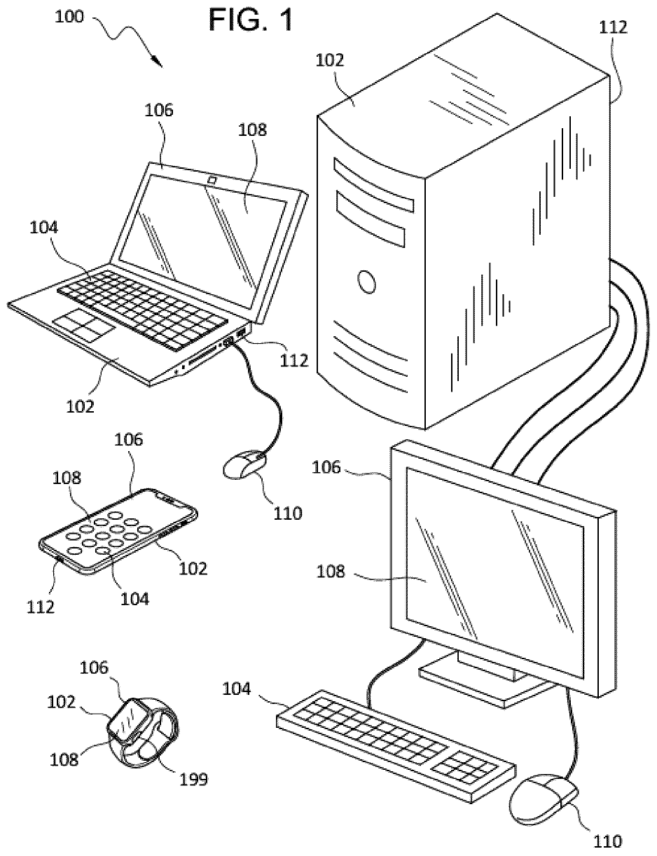

Turning to the drawings, FIG. 1 illustrates embodiments of three different types (e.g., a laptop, a tower server, a smartphone, and a smartwatch) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

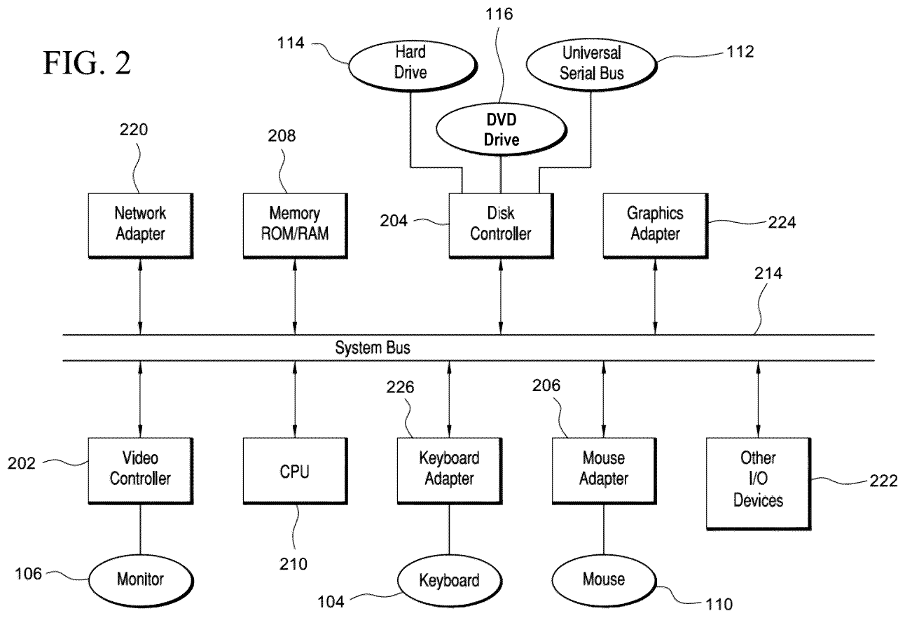

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, a smartphone, and/or a smartwatch in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### Exemplary Computer Systems for Collecting and Tracking Data

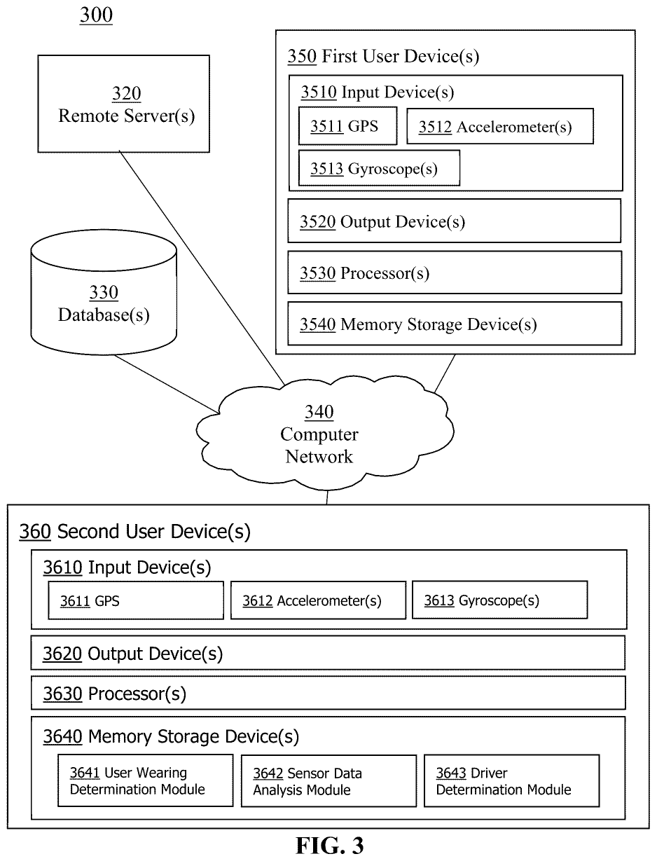

Turning ahead in the drawings, FIG. 3 illustrates a block diagram of a system 300 for collecting data, which can include improving telematics systems, validating data that is collected, verifying the integrity of such data, determining whether a person in a moving vehicle is the operator of the vehicle or merely a passenger, determining that telematics data for a moving vehicle is associated with a particular operator, using additional information collected from a wearable device to improve activity classification, and/or using telematics data collected by one electronic device to validate or verify telematics data collected by another electronic device, according to various embodiments. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more databases (e.g., a database(s) 330), one or more remote servers (e.g., a remote server(s) 320), one or more first user devices (e.g., a first user device(s) 350), and one or more second user devices (e.g., a second user device(s) 360). Database(s) 330, remote server(s) 320, first user device(s) 350, and second user device(s) 360 can each be a computer system, such as computer system 100 (FIG. 1), as described above, and can each be a single computer, a single server, or a cluster or collection of computers or servers, or a cloud of computers or servers. In another embodiment, a single computer system can host each of database(s) 330, remote server(s) 320, first user device(s) 350, and second user device(s) 360.

In many embodiments, each of first user device(s) 350 and second user device(s) 360 can include modules of computing instructions (e.g., software modules) stored on non-transitory computer readable media that operate on one or more processors. In other embodiments, each of first user device(s) 350 and second user device(s) 360 can be implemented in hardware, including ASICs (application specific integrated circuits) and the like. In many embodiments, second user device(s) 360 can comprise one or more systems, subsystems, modules, models, or servers (e.g., a user wearing determination module 3641, a sensor data analysis module 3642, and an operator determination module 3643, etc.). Each of user wearing determination module 3641, sensor data analysis module 3642, and operator determination module 3643 can be implemented, at least in part, in software and/or firmware stored in or loaded on a memory storage device(s) in second user device(s) 360 and executed on processor(s) 3630. In various embodiments, one or more of user wearing determination module 3641, sensor data analysis module 3642, or operator determination module 3643 can include one or more of trained machine learning (ML) and/or artificial intelligence (AI) models (the ML/AI models). In some embodiments, the internal components of first user device(s) 350 can be similar or identical to the internal components of second user device(s) 360. Additional details regarding database(s) 330, remote server(s) 320, first user device(s) 350, and second user device(s) 360 are described herein.

In some embodiments, each of first user device(s) 350 and second user device(s) 360 can be in data communication, through a computer network, a telephone network, or the Internet (e.g., computer network 340), with remote server(s) 320, database(s) 330, and/or each other. In other embodiments, first user device(s) 350 and second user device(s) 360 are in direct communication with each other using, for example, Bluetooth communication. In some embodiments, first user device(s) 350 and second user device(s) 360 can be used by users, such as operators of vehicles.

In certain embodiments, first user device(s) 350, second user device(s) 360, and/or remote server(s) 320 can host one or more websites and/or mobile application servers. For example, first user device(s) 350, second user device(s) 360, and/or remote server(s) 320 can host a website, or provide a server that interfaces with an application (e.g., a mobile application or a web browser), on first user device(s) 350. In some embodiments, an internal network (e.g., computer network 340) that is not open to the public can be used for communications between first user device(s) 350, second user device(s) 360, database(s) 330, and/or remote server(s) 320 within system 300.

In many embodiments, each of first user device(s) 350 and second user device(s) 360, can include one or more input devices (e.g., input device(s) 3510 of first user device(s) 350, and input device(s) 3610 of second user device(s) 360), one or more output devices (e.g., output device(s) 3520 of first user device(s) 350, and output device(s) 3620 of second user device(s) 360), one or more processors (e.g., processor(s) 3530 of first user device(s) 350, and processor(s) 3630 of second user device(s) 360), and/or one or more memory storage devices (e.g., memory storage device(s) 3540 of first user device(s) 350, and memory storage device(s) 3640 of second user device(s) 360). Examples of input device(s) 3510 and 3610 can include one or more keyboards, one or more keypads, one or more pointing devices such as a computer mouse or computer mice, one or more touchscreen displays, a microphone, a camera, mechanical or electronic keyboard 104 (FIG. 1), mouse 110 (FIG. 1), etc. Examples of output device(s) 3520 and 3620 can include one or more monitors, one or more touch screen displays, projectors, monitors 106 (FIG. 1), screens 108 (FIG. 1), etc. Other examples of output device(s) 3520 and 3620 can include other I/O device 222 (FIG. 2), network adapter 220, wireless transmitters, wired transmitters, and the like. Examples of processor(s) 3530 and 3630 can include CPU 210 (FIG. 2), etc. Examples of memory storage device(s) 3540 and 3640 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In various embodiments, memory storage device(s) 3540 and/or 3640 can include a neural processing unit (i.e., neural engine) used to execute on-device machine learning models, as explained below. In a number of embodiments, input device(s) 3510 and 3610 further can include one or more cameras and/or one or more microphones. In the same or different embodiments, input device(s) 3510 and 3610 can include one or more GPS (Global Positioning System) sensor(s) (e.g., GPS sensor(s) 3511 of first user device(s) 350, and GPS sensor(s) 3611 of second user device(s) 360), one or more accelerometers (e.g., accelerometer(s) 3512 of first user device(s) 350, and accelerometer(s) 3612 of second user device(s) 360), one or more gyroscopes (e.g., gyroscope(s) 3513 of first user device(s) 350, and gyroscope(s) 3613 of second user device(s) 360), and/or one or more magnetometers (not shown in FIG. 3)).

Input device(s) 3510 and 3610 and output device(s) 3520 and 3620 can be coupled to their respective first user device(s) 350 and second user device(s) 360 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of first user device(s) 350. In a similar manner, processor(s) 3530 and/or memory storage device(s) 3540 can be local and/or remote to each other. As another example of an indirect manner (which can or cannot also be a remote manner), a keyboard-video-mouse (KVM) switch can be used to couple input device(s) 3610 and output device(s) 3620 to processor(s) 3630 and/or memory storage device(s) 3640. In some embodiments, the KVM switch also can be part of second user device(s) 360. In a similar manner, processor(s) 3630 and/or memory storage device(s) 3640 can be local and/or remote to each other.

In certain embodiments, the user devices (e.g., first user device(s) 350 and second user device(s) 360) can be mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart contacts, smart watches, smart rings, smart bracelets, other smart jewelry, smart headbands, augmented-reality (AR) headsets, virtual-reality (VR) headsets, etc.), or another portable computer device with the capability to present audio and/or visual data (e.g., images, videos, music, etc.). In a specific embodiment of FIG. 3, first user device(s) 350 can be one or more smartphones, and second user device(s) 360 can be one or more smart watches, smart bracelets, smart rings, other smart jewelry, smart headbands, smart glasses, and/or smart contacts.

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, (iv) a Galaxy™ Tab, Smartphone or Ring or similar product by the Samsung Group of Samsung Town, Seoul, South Korea, and/or (v) an Oura® Ring or similar product by Oura Health Oy of Oulu, Finland. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

Meanwhile, in many embodiments, first user device(s) 350 and/or second user device(s) 360 also can be configured to communicate with one or more databases (e.g., a database(s) 330) and/or one or more remote server(s) 320. The one or more databases can include a member database that contains information about the demographic and/or geographic information of members of a population (e.g., insurance policyholders for an insurance company, etc.). The demographic and/or geographic information of the members can include the ages, genders, residences, insurance policies, premiums, payment history, and/or claim histories for the members, for example, among other information. The same or different databases can include telematics data for such members, and/or electronic ledgers related to the telematics data. The one or more databases additionally can include one or more of trained machine learning (ML) and/or artificial intelligence (AI) models (the ML/AI models) used in system 300, remote server(s) 320, first user device(s) 350, and/or second user device(s) 360. The one or more databases further can include training datasets for various ML/AI models, modules, or systems. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, first user device(s) 350, second user device(s) 360, remote server(s) 320, and/or database(s) 330 can be implemented using any suitable manner of wired and/or wireless communication. Accordingly, system 300, first user device(s) 350, second user device(s) 360, and/or database(s) 330 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, remote server(s) 320, first user device(s) 350, and/or second user device(s) 360 can be configured to transmit, to a user device (e.g., remote server(s) 320 transmit to first user device(s) 350, or first user device(s) 350 transmit to second user device(s) 360, etc.) of a user, or to a graphical user interface (e.g., a webpage, a graphical user interface of a mobile application, etc.) for display on the user device. The graphical user interface can include statistics, warnings, notices, motivational messages, requests for user confirmation, discounts for insurance premiums, and the like. Remote server(s) 320, first user device(s) 350, and/or second user device(s) 360 can determine, by using any suitable approaches or ML/AI models, the statistics, warnings, notices, motivational messages, requests, discounts, and other information. Exemplary algorithms for the ML/AI models for determining the information can include decision trees, K Nearest Neighbor (KNN), neural networks, CatBoost, support vector machine, etc.

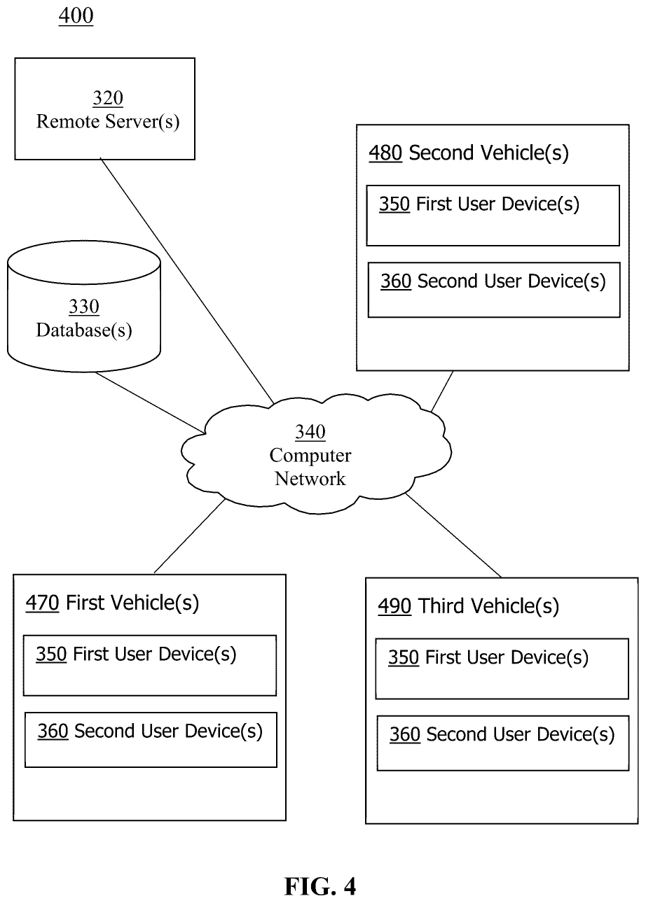

Turning further ahead in the drawings, FIG. 4 illustrates a block diagram of a system 400 for collecting data, which can include improving telematics systems, validating data that is collected, verifying the integrity of such data, determining whether a person in a moving vehicle is the operator of the vehicle or merely a passenger, determining that telematics data for a moving vehicle is associated with a particular operator, using additional information collected from a wearable device to improve activity classification, and/or using telematics data collected by one electronic device to validate or verify telematics data collected by another electronic device, according to various embodiments. System 400 is exemplary, and embodiments of the system are not limited to the embodiments presented herein. The system can be employed in many different embodiments or examples not specifically depicted or described herein. In some embodiments, certain elements, modules, or systems of system 400 can perform various procedures, processes, operations, actions, and/or activities. In other embodiments, the procedures, processes, operations, actions, and/or activities can be performed by other suitable elements, modules, or systems of system 400.

Generally, therefore, system 400 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 400 described herein.

System 400 can include remote server(s) 320, database(s) 330, and computer network 340. System 400 also can include first vehicle(s) 470, second vehicle(s) 480, and third vehicle(s) 490, and each of first vehicle(s) 470, second vehicle(s) 480, and third vehicle(s) 490 can include first user device(s) 350 and second user device(s) 360, as shown in FIG. 4. In various embodiments, first vehicle(s) 470, second vehicle(s) 480, and third vehicle(s) 490 can be automobiles, trucks, or vans. In other embodiments, first vehicle(s) 470, second vehicle(s) 480, and third vehicle(s) 490 can be motorcycles, bicycles, boats, or ships. Each of first vehicle(s) 470, second vehicle(s) 480, and third vehicle(s) 490 can be the same type of vehicle in some embodiments of system 400, and can be different types of vehicles in other embodiments of system 400.

In a first embodiment of FIG. 4, each of first vehicle(s) 470, second vehicle(s) 480, and third vehicle(s) 490 can include two or three pairs of first user device(s) 350 and second user device(s) 360. In other embodiments, each of first vehicle(s) 470, second vehicle(s) 480, and third vehicle(s) 490 can include different numbers of pairs of first user device(s) 350 and second user device(s) 360, or even different numbers of first user device(s) 350 and second user device(s) 360.

Returning to the first embodiment of FIG. 4, first user device(s) 350 and second user device(s) 360 in a first one of first vehicle(s) 470 can be smartphones and smart watches, respectively. In other embodiments, second user device(s) 360 can be one or more of smart rings, smart bracelets, other smart jewelry, smart headbands, smart glasses, and/or smart contacts, and in further embodiments, one of second user device(s) 360 can be a smart ring while two of second user device(s) can be smart watches, and so on.

Also in the first embodiment of FIG. 4, a first one of first user device(s) 350 and a first one of second user device(s) 360 in the first one of first vehicle(s) 470 can be wirelessly paired together via a first Bluetooth connection in the first one of first vehicle(s) 470; a second one of first user device(s) 350 and a second one of second user device(s) 360 in the first one of first vehicle(s) 470 can be paired together via a second Bluetooth connection in the first one of first vehicle(s) 470; and a third one of first user device(s) 350 and a third one of second user device(s) 360 in the first one of first vehicle(s) 470 can be paired together via a third Bluetooth connection in the first one of first vehicle(s) 470. In other embodiments, second user device(s) 360 and second user device(s) 350 are coupled together using different wireless or wired connections.

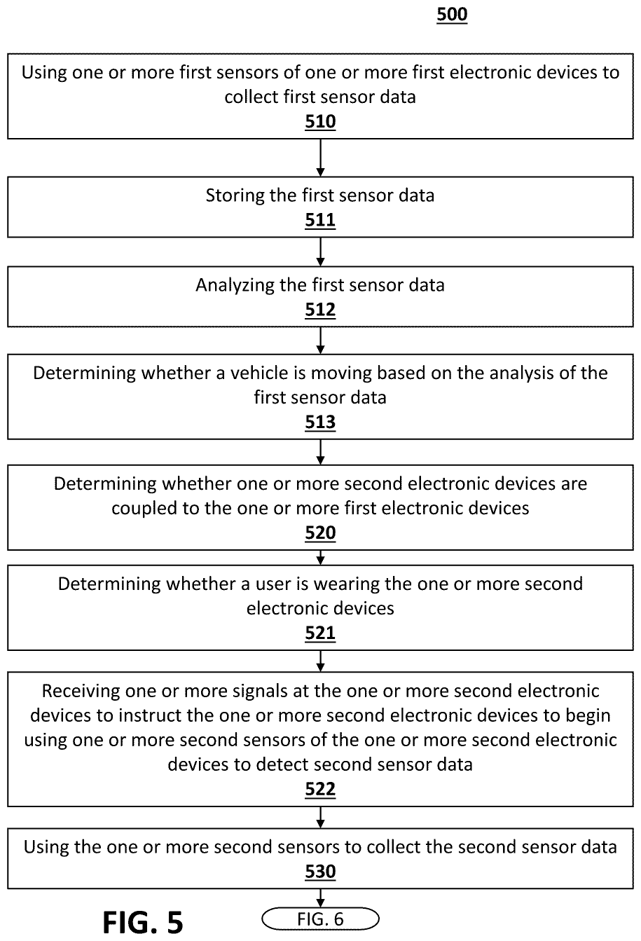

Further in the first embodiment of FIG. 4 and as explained further below with respect to FIGS. 5, 6, and 7, sensor data collected by at least one of second user device(s) 360 in the first one of first vehicle(s) 470 is used to validate or verify sensor data collected by at least one of first user device(s) 350 in the first one of first vehicle(s) 470, where the at least one of first user device(s) 350 is paired together with the at least one of second user device(s) 360 in the first one of first vehicle(s) 470.

### Exemplary Methods and Computer Instructions for Collecting Data

Turning ahead in the drawings, FIGS. 5, 6, and 7 illustrate actions of a method 500 for collecting data, which can include improving telematics systems, validating data that is collected, verifying the integrity of such data, determining whether a person in a moving vehicle is the operator of the vehicle or merely a passenger, determining that telematics data for a moving vehicle is associated with a particular operator, using additional information collected from a wearable device to improve the activity classification, and/or using telematics data collected by one electronic device to validate or verify telematics data collected by another electronic device, according to certain embodiments. Method 500 can be implemented via execution of computing instructions configured to run on one or more processors and stored on one or more non-transitory computer-readable media, and/or via one or more ASICs. Method 500 is exemplary and is not limited to the embodiments presented herein. Method 500 can be employed in many different embodiments or examples not specifically depicted or described herein.

In some embodiments, the procedures, the processes, the operations, the actions, and/or the activities of method 500 can be performed in the order presented. In other embodiments, the procedures, the processes, the operations, the actions, and/or the activities of method 500 can be performed in any suitable order. In still other embodiments, one or more of the procedures, the processes, the operations, the actions, and/or the activities of method 500 can be combined together or skipped.

In many embodiments, system 300 (FIG. 3) or system 400 (FIG. 4) (including one or more of its elements, modules, and/or systems, such as a neural processing unit or neural engine used to execute the on-device machine learning models and/or such as user wearing determination module 3641 (FIG. 3), a sensor data analysis module 3642 (FIG. 3), an operator determination module 3643 (FIG. 3), other aspects of second user device(s) 360, various aspects of first user device(s) 350, etc.) can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), system 400 (FIG. 4), first user device(s) 350 (FIGS. 3 and 4), or second user device(s) 360 (FIGS. 3 and 4). The processor(s) can be similar or identical to the processor(s) described above with respect to computer system 100 (FIG. 1).

Referring to FIG. 5, in many embodiments, method 500 can include a block 510 of using one or more first sensors of one or more first electronic devices to collect first sensor data. Accordingly, block 510 can be performed by the one or more first electronic devices. In some embodiments, the one or more first electronic devices can comprise one or more smartphones; the one or more first sensors can comprise any of one or more of GPS sensors, accelerometers, or gyroscopes; and the first sensor data can comprise any of one or more of GPS data, accelerometer data, or gyroscope data. In other embodiments, the one or more first electronic devices can comprise a vehicle's infotainment system; the one or more first sensors can comprise GPS sensors, accelerometers, or gyroscopes; and the first sensor data can comprise any of one or more of GPS data, accelerometer data, or gyroscope data. As an example, GPS data can include data regarding speed, acceleration, deceleration, elevation, incline, decline, pitch, yaw, etc.; accelerometer data can include data regarding acceleration, deceleration, etc.; and gyroscope data can include data regarding incline, decline, pitch, yaw, etc.

Next, method 500 can include a block 511 of storing the first sensor data. Then, method 500 can include a block 512 of analyzing the first sensor data. Subsequently, method 500 can include a block 513 of determining whether a vehicle is moving based on the analysis of the first sensor data. For example, when the one or more first electronic devices comprise one or more smartphones, if the analysis of the first sensor data indicates movement, but the movement is slow (e.g., 2 or 3 miles per hour), then block 513 can determine that the one or more first electronic devices are not located in a vehicle, that a vehicle is not moving, and/or that a user of the one or more smartphones is walking. However, when the one or more first electronic devices comprise one or more smartphones, if the analysis of the first sensor data indicates movement and the movement is faster (e.g., 15 or 30 miles per hour), then block 513 can determine that the one or more electronic devices are located in a vehicle and that the vehicle is moving. In other embodiments, the analysis can determine that the one or more electronic devices are located in a moving vehicle if the first sensor data indicates movement that is faster than 5 miles per hour, 10 miles per hour, etc. In many embodiments, blocks 511, 512, and/or 513 can be performed locally by the one or more first electronic devices, and in other embodiments, blocks 511, 512, and/or 513 can be performed remotely by one or more remote servers after the one or more first electronic devices transmit the first sensor data to the remote server. In further embodiments, all or portions of blocks 511, 512, and/or 513 can be performed by the one or more first electronic devices and the one or more remote servers. In other embodiments, blocks 512 and 513 can use geofences to determine that a vehicle is moving.

In same or different embodiments, blocks 512 and/or 513 can include analyzing motion patterns in the first sensor data. For example, the analysis can look for patterns indicative of vehicle movements. In the same or different embodiments, block 512 can include comparing the first sensor data to predetermined motion profiles associated with vehicle movements. The analysis can be performed using a custom activity classification model, such as a neural network classifier, that is trained to model the motion associated with vehicle movements. For example, when the first electronic device is a smartphone, the neural network classifier can be trained to identify the motion of moving vehicle, as measured by a smartphone located in the vehicle that is moving. The neural network classifier can take into consideration vehicle motion types, vehicle acceleration in X, Y, and Z axes, as well as rotation rate in X, Y, and Z axes for a vehicle in motion. In these embodiments, as an example, the classification model can output, among other things, two classifications (e.g., vehicle moving or vehicle not moving), three classifications (e.g., vehicle moving, vehicle not moving, or undetermined), or many classifications (e.g., automobile (or truck or van) moving, stationary, walking, running, motorcycle moving, bicycle moving, undetermined, boat moving, ship moving, etc.). The techniques described herein (including the additional information collected by such techniques) can be used to improve existing activity classifications and/or create new activity classifications.

In some embodiments, blocks 512 and/or 513 can include calculating a probability that the vehicle is moving based on the analysis of the first sensor data. For instance, the probability can be calculated using a machine learning model trained on sensor data from known vehicle movements. In other embodiments, blocks 512 and/or 513 can include comparing the calculated probability to a predetermined threshold to determine if the vehicle is moving. The determination can be made at the beginning of a vehicle trip. In other embodiments, block 513 can be performed by or the determination of block 513 can be confirmed by requesting feedback from the user regarding whether a vehicle is moving (in which case blocks 510, 511, and 512 can be omitted).

After block 513, method 500 can continue with a block 520 for determining whether one or more second electronic devices are coupled to the one or more first electronic devices. The one or more first electronic devices can perform at least a portion of block 520. In many embodiments, block 520 occurs only after block 513 determines that the vehicle is moving and, if necessary, that the one or more first electronic devices are located in the vehicle. The one or more second electronic devices can comprise one or more of one or more smart watches, smart bracelets, smart rings, other smart jewelry, smart glasses, smart contacts, or the like. The one or more second electronic devices can be coupled to the one or more first electronic devices in a wired and/or wireless manner. When coupled together in a wireless manner, Bluetooth technology can be used in some embodiments.

Method 500 can continue with a block 521 of determining whether a user is wearing one or more second electronic devices. The one or more second electronic devices can perform block 521, and in other embodiments, the one or more first electronic devices or the one or more remote servers can perform block 521 with the one or more second electronic devices. In many embodiments, block 521 occurs only after block 520 determines that the one or more second electronic devices are coupled to the one or more first electronic devices. In these same or different embodiments, block 521 occurs only after block 513 determines that the vehicle is moving, or only while the vehicle is moving. In other embodiments, block 521 can be performed before or simultaneously with any of blocks 510, 511, 512, and/or 513.

Block 521 can include determining whether a user is wearing the one or more second electronic devices on or over at least one of an arm, a wrist, a hand, a finger, or a thumb of the user. In other embodiments, block 521 can include determining whether the user is wearing the one or more second electronic devices on or over at least one of a face, one or more eyes, or a forehead or head of the user. In still further embodiments, block 521 can include determining whether the user is wearing the one or more second electronic devices in at least one of one or more ears of the user. Accordingly, in general, block 521 can include determining whether the user is wearing the one or more second electronic devices on, over, or in a body part of the user.

Block 521 also can include the one or more first electronic devices instructing the one or more second electronic devices that are coupled to the one or more first electronic devices to perform block 521. Accordingly, in these embodiments, the one or more first electronic devices can perform at least portion of block 521.

Furthermore, to perform block 521, the one or more second electronic devices can use one or more sensors of the one or more second electronic devices to determine whether the user is wearing the one or more second electronic devices. As an example, when the one or more second electronic devices comprise a smart watch, a smart ring, or other wearable smart device, the wearable smart device can include sensors such as heart rate sensors, skin contact sensors, accelerometers, gyroscopes, and/or other motion sensors, and/or magnetometers. More specifically, a heart rate sensor can be an optical hear rate sensor, which employs PhotoPlethysmoGraphy (PPG) technology. This sensor emits InfraRed (IR) light that reflects off the skin and blood vessels, and the reflected light is then measured. If the watch is not on the wrist, the IR light does not reflect back to the sensor, and the smart watch or smart ring recognizes that it is not being worn. Additionally, the one or more second electronic devices can also comprise a Low Latency Off-Body sensor, which enhances the accuracy of wear detection.

In these and other embodiments, when the one or more second electronic devices performs block 521, method 500 can be performed faster and/or more efficiently because of the local processing by the same device(s) that perform the sensor data collection. In the same or different embodiments, to conserve battery power for the one or more second electronic devices, the one or more sensors used to perform block 521 can be turned on when the one or more second electronic devices receive one or more signals from the one or more first electronic devices instructing the one or more second electronic devices to perform block 521, and the one or more sensors can be turned off after the performance of block 521 to conserve battery life for the second electronic device. In these embodiments, the one or more sensors can be turned on for less than 1 second or less than 5 seconds. In other embodiments, block 521 can be performed by receiving active or affirmative user input or feedback from the first electronic device or the second electronic device indicating that the user is wearing the one or more second electronic devices (e.g., the user pushes a physical button on the first or second electronic device or an electronic button on a touchscreen of the first or second electronic device to answer a question indicating that the user is wearing the second electronic device).

After block 521, method 500 can continue with a block 522 of receiving one or more signals at the one or more second electronic devices to instruct the one or more second electronic devices to begin using one or more second sensors of the one or more second electronic devices to detect second sensor data. Accordingly, the one or more second electronic devices can perform block 522. As an example, the one or more signals can be used to activate the one or more second sensors of the one or more second electronic devices after a vehicle trip is determined to have started in block 513, because it may be too battery-intensive to continuously monitor or use the one or more second sensors of the one or more second electronic devices before the vehicle trip starts. In other embodiments, geofences or significant location change events in short periods of time monitored by the one or more second electronic devices can be used to wake up one or more apps and/or the one or more second sensors of the one or more second electronic devices and begin using the one or more second sensors of the one or more second electronic devices to detect second sensor data. These one or more second sensors of the one or more second electronic devices in block 522 are different form the one or more sensors of the one or more second electronic devices used in block 521.

In some embodiments, block 522 can include receiving the one or more signals from the one or more first electronic devices. In various embodiments, the one or more signals can be wireless or wired signals. For example, in one embodiment of block 522, a mobile electronic device can send a Bluetooth, WiFi, or other wireless signal to a wearable electronic device after the mobile electronic device detects that it is in a moving vehicle (block 513), and after the mobile electronic device detects that it is coupled to the wearable electronic device (block 520), and after the wearable electronic device determines that it is worn by a user (block 521). In other embodiments, block 522 can include receiving the one or more signals from a vehicle electronic system of the moving vehicle. For instance, the vehicle's infotainment system can transmit a signal to a wearable device that the wearable device has determined is being worn by a user after the infotainment system determines that the vehicle is moving and the wearable device is in the vehicle.

In other embodiments, block 522 is not used in method 500, and instead, the user can affirmatively authorize an app on the second electronic device to use the second sensors on the second electronic device to collect the second sensor data. The user can authorize the app to use the second sensors to collect the second sensor data before the vehicle trips begins or at the beginning of the vehicle trip.

After block 522, method 500 can include a block 530 of using the one or more second sensors of the one or more second electronic devices to collect the second sensor data. Accordingly, the one or more second electronic devices can be used to perform block 530. In embodiments where the one or more second electronic devices comprise one or more wearable electronic devices that are determined to be worn by the user, as explained above, the one or more second sensors of the one or more second electronic devices can comprise any of one or more of GPS sensors, accelerometers, gyroscopes, or other motion-related sensors that can be used to analyze the user's movements, and the second sensor data can comprise any of one or more of GPS data, accelerometer data, gyroscope data, or the like. In some embodiments, the second sensor data can be detected only periodically by the one or more sensors to conserve battery life. In other embodiments, the second sensor data is detected continuously. The one or more second sensors of the one or more second electronic devices are different sensors from the sensors used to perform block 521. To conserve battery life for the one or more second electronic devices, the one or more second sensors can be turned off after block 530 is completed, and in the same or different embodiments, the one or more second sensors can be turned on during or after block 522 and can remain on during block 530 for a few seconds (e.g., if the user's hand is on a steering wheel of the vehicle and the hand is on arm that has the wrist on which the smart watch is worn) or for ten to fifty times longer (e.g., if the user's finger wearing the smart ring is not on a hand that is on a steering wheel of the vehicle) before being turned off.

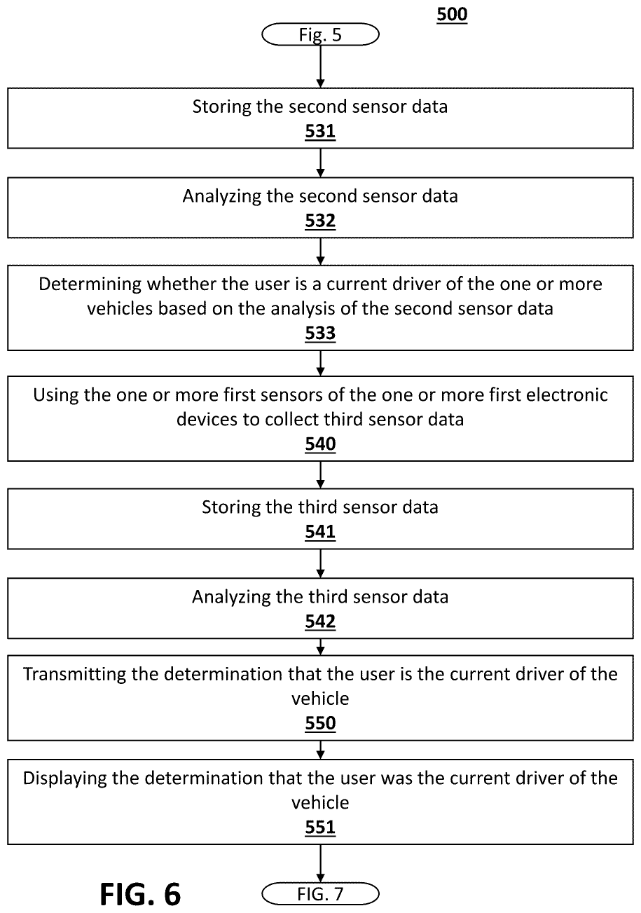

Then, moving from FIG. 5 to FIG. 6, method 500 can continue with a block 531 of storing the second sensor data, and then method 500 can further continue with a block 532 of analyzing the second sensor data and then a block 533 of determining whether the user who is wearing the one or more second electronic devices is a current operator of the moving vehicle based on the analysis of the second sensor data. The one or more second electronic devices can locally perform blocks 531, 532, and 533, and in these embodiments, method 500 can be performed faster and/or more efficiently due to the local performance of blocks 531 532, and 533 by the same device that performs block 530 (FIG. 5). In other embodiments, the one or more first electronic devices or the one or more remote servers can remotely perform all or a portion of blocks 531, 532, and 533 after the one or more second electronic devices transmit the second sensor data to the one or more first electronic devices and/or the one or more remote servers (either after the second electronic devices transmit the second sensor data to the one or more first electronic devices or without transmitting the second sensor data to the one or more first electronic devices). In further embodiments, all or portions of blocks 531, 532, and 533 can be performed by one or more of the one or more first electronic devices, the one or more second electronic devices, and/or the one or more remote servers.

Block 533 can include analyzing motion patterns in the second sensor data. For example, the analysis can look for patterns indicative of steering wheel movements, gear shifting actions, or resting an arm on the driver's side door or side door arm rest. In the same or different embodiments, block 533 can include comparing the second sensor data to predetermined motion profiles associated with driving activities. The analysis can be performed using a custom activity classification model, such as a neural network classifier, that is trained to model the motion associated with driving activities. For example, when the second electronic device is a smart watch that is worn on the left hand of a user, the neural network classifier can be trained to identify the motion of a user's left wrist while on a steering wheel driving a vehicle. The neural network classifier can take into consideration wrist motion types, wrist acceleration in X, Y, and Z axes, as well as rotation rate in X, Y, and Z axes for the user's wrist. In these embodiments, as an example, the classification model can output, among other things, two classifications (e.g., driver or non-driver, or operator or non-operator) or three classifications (e.g., driver/operator, non-driver/non-operator, or undetermined). The techniques described herein (including the additional information collected by such techniques) can be used to improve existing activity classifications and/or create new activity classifications.

In some embodiments, block 533 can include calculating a probability that the user is the current operator based on the analysis of the second sensor data. For instance, the probability can be calculated using a machine learning model trained on sensor data from known operators and passengers in vehicles, along with their known behaviors (i.e., body movements). In other embodiments, block 533 can include comparing the calculated probability to a predetermined threshold to determine if the user is the current operator. The determination can be made in real-time, at the beginning of a vehicle trip, in the middle of the vehicle trip, at the end of the vehicle trip, or after the vehicle trip. The determination also can be made periodically (i.e., multiple times) during the vehicle trip to periodically confirm or validate the previous determination that the user is the current operator. In other embodiments, block 533 can be performed by or the determination of block 533 can be confirmed by requesting feedback from the user regarding whether the user (e.g., who is wearing the second electronic device) is or was an operator of a vehicle that was moving.

After block 533, method 500 in FIG. 6 can continue with a block 540 of using the one or more first sensors of the one or more first electronic devices to collect third sensor data. Accordingly, the one or more first electronic devices can perform block 540. As indicated previously, the one or more first electronic devices can comprise one or more smartphones or a vehicle's infotainment system, etc., so in many embodiments, the third sensor data can be the same type of data as the first sensor data described above with reference to blocks 510, 511, 512, and 513 (FIG. 5). In many embodiments, the third sensor data comprises GPS data that tracks the movement of the vehicle during a vehicle trip and the driving behavior of the user during the vehicle trip while the user wears the one or more second electronic devices during the vehicle trip.

Next, method 500 can include a block 541 of storing the third sensor data, and a block 542 of analyzing the third sensor data. In some embodiments, block 542 is not performed, or is performed at a later time. The one or more first electronic devices can perform blocks 541 and 542. In other embodiments, the one or more remote servers can perform blocks 541 and 542 after the one or more first electronic devices transmit the third sensor data to the one or more remote servers. In further embodiments, all or portions of blocks 541 and 542 can be performed by the one or more first electronic devices and the one or more remote servers.

In various embodiments, the performance of the sequence of blocks 540, 541, and 542 can be repeated over and over during the vehicle trip. Similarly, in the same or different embodiments, the performance of the sequence of blocks 530 (FIG. 5), 531, 532, and 533 can be repeated over and over during the vehicle trip. In some embodiments, the repetition of the sequence of blocks 530 (FIG. 5), 531, 532, and 533 can occur, if at all, only periodically and less frequently than the repetition of the sequence of blocks 540, 541, and 542. In the same or different embodiments, the repetition of the sequence of blocks 530 (FIG. 5), 531, 532, and 533 can occur in parallel or serially with the repetition of the sequence of blocks 540, 541, and 542. In this manner, the second sensor data of 530 (FIG. 5), 531, 532, and 533 can be used to validate and/or verify the integrity of the third sensor data of blocks 540, 541, and 542. For example, during a vehicle trip, blocks 530 (FIG. 5), 531, 532, and 533 can be performed in that sequence a first time, and then blocks 540, 541, and 542 can be performed in that sequence many times in a row, and then blocks 530 (FIG. 5), 531, 532, and 533 can be performed a second time in that sequence (i.e., repeated in that sequence only once) while blocks 540, 541, and 542 are performed again in that sequence many times in a row. During any of these repetitions, in various embodiments, less than the entire sequence of blocks can be repeated. For example, in many embodiments, during any sequence of blocks 540, 541, and 542, block 542 can be omitted during each repetition or during only some of the repetitions, and/or block 540 and 541 can be performed simultaneously with each other. Similarly, in many embodiments, during any sequence of blocks 530 (FIG. 5), 531, 532, and 533, blocks 532 and 533 can be omitted during some of the repetitions, and/or blocks 530 (FIG. 5) and 531 can be performed simultaneously with each other.

Continuing with method 500 in FIG. 6, method 500 also can include a block 550 of transmitting the determination that the user is the current operator of the vehicle. If block 533 was performed by the one or more second electronic devices, then the one or more second electronic devices can perform block 550, as well. However, if block 533 was performed by the one or more first electronic devices or the one or more remote servers, then the one or more first electronic devices or the one or more remote servers can perform block 550, as well. Block 550 can occur after block 542 (as shown in FIG. 6), or block 550 can occur earlier in method 500. In many embodiments, the one or more first electronic devices can perform block 550, and the transmission can be sent by the one or more first electronic devices to a remote server. In the same or different embodiments, the one or more second electronic devices can transmit the determination to the one or more first electronic devices, which then in turn can transmit the determination to the remote server. In other embodiments, the one or more second electronic devices transmit the determination to the remote server (without transmitting to the one or more first electronic devices), or the one or more second electronic devices transmit the determination to the one or more first electronic devices without the one or more first electronic devices transmitting the determination to the remote server.

In parallel or in series with block 550, method 500 can perform a block 551 of displaying the determination that the user was the current operator of the vehicle. As an example, the one or more first electronic devices can perform block 551. In a second and different example, the one or more second electronic devices can perform block 551, and in a third and different example, both of the one or more first electronic devices and the one or more second electronic devices can perform block 551. In some embodiments, the performance of block 551 occurs after the vehicle trip ends to avoid distracting the operator of the vehicle.

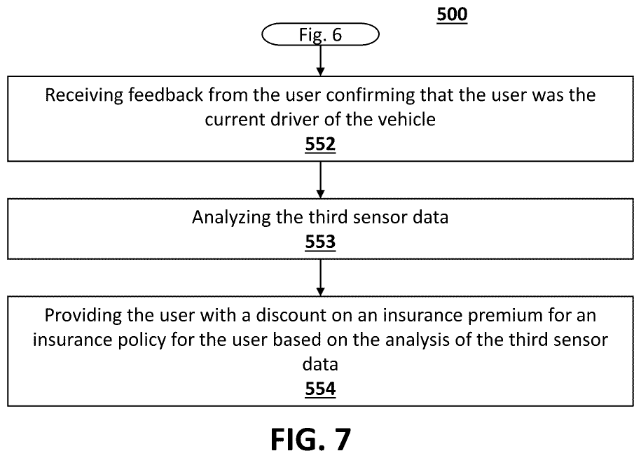

Turning from FIG. 6 to FIG. 7, method 500 can continue with a block 552 of receiving feedback from the user confirming that the user was the current operator of the vehicle. The one or more first electronic devices and/or the one or more second electronic devices can perform block 552. This feedback can be provided through a user interface on the one or more first electronic devices or the one or more second electronic devices. In some embodiments, the feedback can be provided by receiving active or affirmative user input from the one or more first electronic devices or the one or more second electronic devices indicating that the user who was wearing the one or more second electronic devices during the vehicle trip is or was the operator of the vehicle during the vehicle trip. For example, the user can push a physical button on the first or second electronic device or an electronic button on a touchscreen of the first or second electronic device to answer a question indicating that the user is wearing the second electronic device. In some embodiments, the feedback can be used to improve the accuracy of future operator determinations. To avoid distracting the driver or operator, the prompt for feedback may occur only after the trip has been completed. In some embodiments, block 552 is not performed in method 500.

Method 500 also can include a block 553 of analyzing the third sensor data. In other embodiments, block 553 can be omitted from method 500, especially in embodiments where block 542 (FIG. 6) is performed as part of method 500. The one or more first electronic devices and/or the one or more remote servers can perform block 553.

Subsequently, method 500 can include a block 554 of providing the user with a discount on an insurance premium for an insurance policy for the user. The one or more first electronic devices and/or the one or more remote servers can perform block 554. The discount can be based on the analysis of the third sensor data. For example, if the third sensor data indicates safe driving behaviors, the user may be offered a reduced insurance premium for the vehicle, particularly when previous sets of third sensor data also indicated safe driving behaviors. In some embodiments, the discount can be calculated based on a combination of factors derived from (a) the analysis of block 553 of the third sensor data from the vehicle trip and/or (b) the determination in block 533 that the user was the operator of the vehicle during the vehicle trip. This approach can increase user confidence in the system's ability to accurately assess driving behavior and provide appropriate insurance discounts, potentially leading to increased user satisfaction with the insurance program.

Relating FIGS. 3 and 4 to FIGS. 5, 6, and 7, in various embodiments, input device(s) 3510 (FIG. 3) can perform all or a portion of blocks 510 and/or 540; processor(s) 3530 and memory storage device(s) 3540 can perform all or portions of blocks 511, 512, 513, 520, 521, 533, 541, 542, and/or 553; processor(s) 3530, memory storage device(s) 3540, and output device(s) 3520 can perform all or a portion of blocks 550, 551, and/or 554; processor(s) 3530, memory storage device(s) 3540, and input device(s) 3510 can perform all or a portion of block 552; remote server(s) 320 can perform all or portions of blocks 511, 512, 513, 520, 521, 531, 532, 533, 541, 542, 550, 553, and/or 554; database(s) 330 can perform all or portions of blocks 511, 531, and/or 541; processor(s) 3630, memory storage device(s) 3640, and user wearing determination module 3641 can perform all or portions of block 521; processor(s) 3630 and memory storage device(s) 3640 can perform all or portions of blocks 522 and/or 531; processor(s) 3630, memory storage device(s) 3640, and sensor data analysis module 3642 can perform all or portions of block 532; processor(s) 3630, memory storage device(s) 3640, and operator determination module 3643 can determine all or portions of block 533; input device(s) 3610 can perform all or a portion of blocks 530 and/or 552; and processor(s) 3630, memory storage device(s) 3640, and output device(s) 3620 can perform all or a portion of blocks 550, 551, and/or 554.

Although FIGS. 5, 6, and 7 depict method 500 as being sequential, in practice, the method can contain parallel and overlapped steps. As an example, a smartphone can detect when a vehicle trip has started and can begin to collect a primary data stream (i.e., the telematics data) for the vehicle trip. In some embodiments, the primary data stream can be a time series containing data from all of the sensors on the smartphone, and in the same or different embodiments, the data can be sampled at 15-18 Hertz for the duration of the vehicle trip.

The smartphone also can notify a wearable device to begin collecting a secondary data stream. It is also possible for the wearable device to independently determine when a vehicle trip has started and to begin collecting the secondary data stream. In some embodiments, the secondary data stream can be a time series containing vehicle control features (e.g., turn left/right, lane change left/right, tracking straight ahead, reversing direction, and unknown) predicted using an embedded activity classification machine learning model that runs on the wearable device in real-time during the vehicle trip. An associated confidence value for each prediction can be included with the prediction. The vehicle control features can be used as additional inputs during an analysis of the primary data stream.

Collection of the primary and secondary data streams can occur in parallel with each other. In some embodiments, other than both the primary and secondary data streams being tagged or otherwise identified as being for the same user, no further communication between the smartphone and the wearable device is required until after the vehicle trip is completed.

### Exemplary Machine Learning Models

In a number of embodiments where one or more ML/AI models are used in block 512, block 513, block 520, block 521, block 532, block 533, block 542, and/or block 553, method 500 further can include pre-training and/or re-training the trained ML/AI models based upon the collected sensor data from block 510, block 530, and/or block 540, feedback received from a system user (e.g., a data scientist, a machine learning engineer, etc.) or collected from various data sources (e.g., telematics databases, policy renewal rates, insurance claim trends, insurance premium trends, insurance premium discount trends, etc.), and/or synthesized training data. In these embodiments, the same or different ML/AI models can be used in one or more of block 512, block 513, block 520, block 521, block 532, block 533, block 542, and/or block 553 in method 500.

For each of the machine learning models to be retrained, the respective training datasets can be updated manually by a system user (e.g., an ML engineer, a data scientist, etc.) and/or automatically by a system (e.g., system 300 or remote server(s) 320 (FIG. 3)). The system user can select new training data from various data sources (e.g., websites, books, magazines, product catalogs, private third-party databases, etc.). The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. Examples of the user feedback can include when the machine learning model incorrectly classifies whether a user is a current operator of a vehicle, and so forth. In various embodiments, when more than one training dataset is used for the pre-training and/or re-training, the system (e.g., system 300 and/or remote server(s) 320) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers for blocks 512 and/or 513 (FIG. 5) and/or blocks 532 and/or 533 (FIG. 6) can be trained, retrained, and stored locally on the one or more first electronic devices (for blocks 512 and/or 513 (FIG. 5) and/or the one or more second electronic devices (for blocks 532 and/or 533 (FIG. 6). As another example, one or more of these customized classifiers can be trained and/or retrained remotely (e.g., at the one more first electronic devices, the remote servers, etc.) and stored locally. In these examples, the classifiers can be customized to the user wearing the one or more second electronic devices and, in particular for one embodiment, customed to the user's wrist motion when driving a vehicle when the one or more second electronic devices comprises a smart watch.

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In many embodiments, the systems and/or methods can be configured to train or re-train the one or more ML/AI models. The training of each of the ML/AI models can be supervised, semi-supervised, and/or unsupervised-which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### Additional Considerations

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-7 can be modified, and that the foregoing discussion of certain of these embodiments does not necessarily represent a complete description of all possible embodiments. Additionally, one or more of the procedures, processes, operations, actions, and/or activities of the method in FIGS. 5, 6, and 7 can include different procedures, processes, actions, and/or activities and be performed by many different modules, in many different orders. For example, each of the blocks in method 500 (FIGS. 5, 6, and 7) containing an analysis function and/or a determining function can be performed at the beginning of a vehicle trip, in the middle of the vehicle trip, at the end of the vehicle trip, or after the vehicle trip. As another example, the modules, models, elements, and/or systems within systems 300 and 400 in FIGS. 3 and 4, respectively, can be interchanged or otherwise modified. As a further example, specifically for FIGS. 6 and 7, the displaying of the determination that the user was the current driver of the vehicle (block 551 in FIG. 6) and the receiving feedback from the user confirming that the user was the current driver of the vehicle (block 552 in FIG. 7) can be eliminated from method 500 in FIGS. 5, 6, and 7.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method being implemented via execution of computing instructions configured to run on one or more processors and stored on one or more non-transitory computer-readable media, the method comprising:
determining whether a user is wearing one or more wearable electronic devices, wherein when the user is determined to be wearing the one or more wearable electronic devices, the user is wearing the one or more wearable electronic devices on, over, or in a body part of the user; and
after the user is determined to be wearing the one or more wearable electronic devices:
conducting an analysis of sensor data detected by one or more sensors of the one or more wearable electronic devices; and
determining whether the user is a current operator of a vehicle based on the analysis of the sensor data.

2. The method in claim 1, further comprising:
receiving a signal at the one or more wearable electronic devices to instruct the one or more wearable electronic devices to begin using the one or more sensors of the one or more wearable electronic devices to detect the sensor data; and
after receiving the signal, storing the sensor data detected by the one or more sensors.

3. The method in claim 1, wherein the one or more wearable electronic devices comprises a ring, a watch, or a bracelet.

4. The method in claim 1, wherein the one or more sensors of the one or more wearable electronic devices comprise at least one of a gyroscope or an accelerometer.

5. The method in claim 1, wherein the sensor data is detected only periodically by the one or more sensors.

6. The method in claim 1, wherein:
the one or more wearable electronic devices comprises the one or more processors;
determining whether the user is wearing the one or more wearable electronic devices comprises:
determining, using the one or more processors of the one or more wearable electronic devices, whether the user is wearing the one or more wearable electronic devices;
conducting the analysis of the sensor data detected by the one or more sensors of the one or more wearable electronic devices comprises:
conducting, using the one or more processors of the one or more wearable electronic devices, the analysis of the sensor data detected by the one or more sensors of the one or more wearable electronic devices; and
determining whether the user is the current operator of the vehicle based on the analysis of the sensor data comprises:
determining, using the one or more processors of the one or more wearable electronic devices, whether the user is the current operator of the vehicle based on the analysis of the sensor data.

7. The method in claim 1, wherein:
an app on a mobile electronic device determines that the vehicle is moving and that the mobile electronic device is in the vehicle that is moving;
the mobile electronic device communicates wirelessly with the one or more wearable electronic devices that is determined to be worn by the user; and
after the app on the mobile electronic device determines that the mobile electronic device is in the vehicle that is moving and after the mobile electronic device communicates wirelessly with the one or more wearable electronic devices that is determined to be worn by the user, the method performs the conducting the analysis of the sensor data and the determining whether the user is the current operator of the vehicle.

8. A system comprising:
one or more processors; and
one or more non-transitory computer-readable media storing computing instructions that, when run on the one or more processors, cause the one or more processors to perform:
determining whether a user is wearing one or more wearable electronic devices, wherein when the user is determined to be wearing the one or more wearable electronic devices, the user is wearing the one or more wearable electronic devices on, over, or in a body part of the user; and
after the user is determined to be wearing the one or more wearable electronic devices:
conducting an analysis of sensor data detected by one or more sensors of the one or more wearable electronic devices; and
determining whether the user is a current operator of a vehicle based on the analysis of the sensor data.

9. The system in claim 8, wherein the computing instructions, when run on the one or more processors, cause the one or more processors to further perform:
receiving a signal at the one or more wearable electronic devices to instruct the one or more wearable electronic devices to begin using the one or more sensors of the one or more wearable electronic devices to detect the sensor data; and
after receiving the signal, storing the sensor data detected by the one or more sensors.

10. The system in claim 8, wherein the one or more wearable electronic devices comprises a ring, a watch, or a bracelet.

11. The system in claim 8, wherein the one or more sensors of the one or more wearable electronic devices comprise at least one of a gyroscope or an accelerometer.

12. The system in claim 8, wherein the sensor data is detected only periodically by the one or more sensors.

13. The system in claim 8, wherein:
the one or more wearable electronic devices comprises the one or more processors;
determining whether the user is wearing the one or more wearable electronic devices comprises:
determining, using the one or more processors of the one or more wearable electronic devices, whether the user is wearing the one or more wearable electronic devices;
conducting the analysis of the sensor data detected by the one or more sensors of the one or more wearable electronic devices comprises:
conducting, using the one or more processors of the one or more wearable electronic devices, the analysis of the sensor data detected by the one or more sensors of the one or more wearable electronic devices; and
determining whether the user is the current operator of the vehicle based on the analysis of the sensor data comprises:
determining, using the one or more processors of the one or more wearable electronic devices, whether the user is the current operator of the vehicle based on the analysis of the sensor data.

14. The system in claim 8, wherein:
an app on a mobile electronic device determines that the vehicle is moving and that the mobile electronic device is in the vehicle that is moving;
the mobile electronic device communicates wirelessly with the one or more wearable electronic devices that is determined to be worn by the user; and
after the app on the mobile electronic device determines that the mobile electronic device is in the vehicle that is moving and after the mobile electronic device communicates wirelessly with the one or more wearable electronic devices that is determined to be worn by the user, the computing instructions, when run on the one or more processors, cause the one or more processors to further performs the conducting the analysis of the sensor data and the determining whether the user is the current operator of the vehicle.

15. A non-transitory computer readable storage medium storing computing instructions, the computing instructions, when run on one or more processors, causing the one or more processors to perform:
determining whether a user is wearing one or more wearable electronic devices, wherein when the user is determined to be wearing the one or more wearable electronic devices, the user is wearing the one or more wearable electronic devices on, over, or in a body part of the user; and
after the user is determined to be wearing the one or more wearable electronic devices:
conducting an analysis of sensor data detected by one or more sensors of the one or more wearable electronic devices; and
determining whether the user is a current operator of a vehicle based on the analysis of the sensor data.

16. The non-transitory computer readable storage medium in claim 15, wherein the computing instructions, when run on the one or more processors, cause the one or more processors to further perform:
receiving a signal at the one or more wearable electronic devices to instruct the one or more wearable electronic devices to begin using the one or more sensors of the one or more wearable electronic devices to detect the sensor data; and
after receiving the signal, storing the sensor data detected by the one or more sensors.

17. The non-transitory computer readable storage medium in claim 15, wherein at least of:
the one or more wearable electronic devices comprises a ring, a watch, or a bracelet; or
the one or more sensors of the one or more wearable electronic devices comprise at least one of a gyroscope or an accelerometer.

18. The non-transitory computer readable storage medium in claim 15, wherein the sensor data is detected only periodically by the one or more sensors.

19. The non-transitory computer readable storage medium in claim 15, wherein:
the one or more wearable electronic devices comprises the one or more processors;
determining whether the user is wearing the one or more wearable electronic devices comprises:
determining, using the one or more processors of the one or more wearable electronic devices, whether the user is wearing the one or more wearable electronic devices;
conducting the analysis of the sensor data detected by the one or more sensors of the one or more wearable electronic devices comprises:
conducting, using the one or more processors of the one or more wearable electronic devices, the analysis of the sensor data detected by the one or more sensors of the one or more wearable electronic devices; and
determining whether the user is the current operator of the vehicle based on the analysis of the sensor data comprises:
determining, using the one or more processors of the one or more wearable electronic devices, whether the user is the current operator of the vehicle based on the analysis of the sensor data.

20. The non-transitory computer readable storage medium in claim 15, wherein:
an app on a mobile electronic device determines that the vehicle is moving and that the mobile electronic device is in the vehicle that is moving;
the mobile electronic device communicates wirelessly with the one or more wearable electronic devices that is determined to be worn by the user; and
after the app on the mobile electronic device determines that the mobile electronic device is in the vehicle that is moving and after the mobile electronic device communicates wirelessly with the one or more wearable electronic devices that is determined to be worn by the user, the computing instructions, when run on the one or more processors, cause the one or more processors to perform the conducting the analysis of the sensor data and the determining whether the user is the current operator of the vehicle.
